(19) United States
(12) Patent Application Publication
(10) Pub. No.: US 2025/0303280 A1
(43) Pub. Date: Oct. 2, 2025

(54) GAMEPLAY COMPLEXITY ASSISTANCE SYSTEM

(71) Applicant: Electronic Arts Inc., Redwood City, CA (US)

(72) Inventor: Teodor-Luchian Grigore, Bucharest (RO)

(21) Appl. No.: 18/619,582

(22) Filed: Mar. 28, 2024

(51) Int. Cl. A63F 13/422

(52) U.S. Cl. CPC A63F 13/422

(57) ABSTRACT

A system may provide gameplay complexity assistance in gaming. The system operate, during gameplay of a game including a set of controls for a player of the game, a simulated player model to provide gameplay complexity assistance for the player including inputting a game state of the game to the simulated player model to cause the simulated player model to generate at least one simulated control corresponding to at least one control of the set of controls for the player and receiving the at least one simulated control input from the simulated player model. The system may then utilize, in the gameplay of the game, the at least one simulated control input from the simulated player model as a player input of the corresponding one of the set of controls of the player.

### BACKGROUND

Computer gaming systems allow for players to play a variety of electronic and/or video games with alone or each other online via network connectivity, such as via the Internet. As video games grow to have more depth in their gameplay, a rise in the complexity associated with playing a game may occur. Some players, such as younger audiences or those requiring accessibility assistance, may experience an engagement or enjoyment disparity due to the complexity involved in playing the game well. Difficulty selection in games may fail to address this problem as adjusting difficulty does not correspond to adjusting complexities of gameplay. As such, frustration may arise for players due to the engagement or enjoyment disparity.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 illustrates a schematic diagram of an example environment with game system(s), game client device(s) and complexity assisted player client device(s) that enable online gaming, in accordance with example embodiments of the disclosure.

FIG. 2 illustrates an example chart of an example set of player matchmaking information including each player's respective skill score, level of gameplay complexity assistance and opt-in to play with other players receiving gameplay complexity assistance, in accordance with example embodiments of the disclosure.

FIG. 3 illustrates an example view of an example virtual environment of a video game in which gameplay complexity assistance may be provided during gameplay, in accordance with example embodiments of the disclosure.

FIG. 4 illustrates a flow diagram of an example method to match players to form one or more online games including players receiving gameplay complexity assistance, in accordance with example embodiments of the disclosure.

FIG. 5 illustrates a flow diagram of an example method to provide gameplay complexity assistance to one or more players during gameplay of an instance of an online game, in accordance with example embodiments of the disclosure.

FIG. 6 illustrates a block diagram of example matchmaking system(s) that may provide for gameplay complexity assistance in online games, in accordance with example embodiments of the disclosure.

### DETAILED DESCRIPTION

Example embodiments of this disclosure describe methods, apparatuses, computer-readable media, and system(s) for providing gameplay complexity assistance to players. In some examples, players of a video game may receive gameplay complexity assistance that allows players of various skill levels, ability or capability to play a complex game by automating aspects of the game for those players to reduce its overall complexity. In some examples, players of various skill levels, ability or capability may play games solo or together, cooperatively or competitively, with each player able to request an appropriate level of gameplay complexity assistance to aid in the engagement of each player individually.

Complexity of gameplay can be associated with a number of gameplay aspects of a game, such as tactics, strategy, the amount of possible actions, inputs of an input device, among other things. Assisting with gameplay complexity can include simplifying or automating one or more of these aspects.

In some examples, a simulated player model may assist a player through automating or adjusting gameplay actions normally controlled by the player of the video game. For example, the simulated player model may assist a player by determining and providing at least a portion of the video game control inputs for the video game on behalf or in place of the player. In some examples, the gameplay complexity assistance system according to this disclosure may prompt the player for inputs that may be used to influence or to determine the video game control inputs generated by the simulated player model. In some examples, the inputs prompted from the player may be different and/or simplified in comparison to the video game control inputs determined by the simulated player model on behalf of the player. For example, a simulated player model may be instantiated in a cooperative sports game to control the player character avatar of a player who has requested gameplay complexity assistance. In an example in which the player requesting assistance has a low skill level, ability or capability, the simulated player model may act as a computer-controlled player character (e.g., a bot) while the gameplay complexity assistance system may prompt inputs from the player that may influence the actions of the computer-controlled player character that are generated by the simulated player model (e.g., influencing an accuracy or success chance of an in-game action of the simulated player model to kick or throw a ball, hit a target, choose a correct path in a maze, choose a strategy and so on). This level of assistance may be reduced as the skill level, ability or capability of the player increases or based on preferences of the player. In an example in which the player requesting assistance has an intermediate level of skill, ability or capability, the simulated player model may act in the same way as for players with low skill level, ability or capability for some controls or aspects of controlling the player character while leaving other controls or aspects of controlling the player character to the player. Another potential intermediate level of gameplay complexity assistance may include the simulated player model handling minimal controls or suggesting controls based on what the simulated player model would control the player character to do. Finally, players may choose to disable or turn off the gameplay complexity assistance system for their gameplay entirely. These and other levels or types of gameplay complexity assistance are discussed below in more detail.

In some examples, the level of gameplay complexity assistance may be determined based on a player profile that can be configured by the player or otherwise determined by the system. Additionally, in some examples, the gameplay complexity assistance system may adjust a difficulty and other settings in a game to more optimally assist players.

As discussed in more detail below, in some examples, a gaming system may determine one or more players wish to play a game (e.g., an online game). The gaming system may then determine simulated player models for players of the one or more players wishing to play the game that are requesting gameplay complexity assistance. The gameplay complexity assistance system may further configure the simulated player models or a system controlling the simulated player models to provide the level of gameplay complexity assistance requested by the players. The gaming system may then instantiate and conduct the instance of the game for the one or more players such that gameplay complexity assistance is provided by the simulated player models.

In some examples, the gaming system may begin an instance of the game for the one or more players including instantiating the configured simulated player models for the players requesting gameplay complexity assistance. The gaming system may then begin gameplay which may include operating the simulated player models to perform game controls in place of the corresponding players for at least some controls of the player's character. The gaming system may monitor the operation of the simulated player models to determine the occurrence of a gameplay complexity interaction trigger. A gameplay complexity interaction trigger may be an event or point in gameplay at which the simulated player model is configured to perform an in-game action based on a prompted input from the player (e.g., a reduced complexity input). In response, the gaming system may present a prompt to the player for the interaction trigger and receive a player input in response to the prompt. The prompt may include a check or test for success for the prompted input (e.g., whether correct buttons are pressed, a timing, or so on). The gaming system may then control the simulated player model for at least one action associated with the interaction trigger based on the player input. In some examples, the degree of success the player had in inputting the prompted input may be used to determine how well the simulated player model performs the in-game action. A more specific example is presented below.

In an example, a first player with low skill, ability, or capability may wish to play a game with a second player with normal or high skill, ability and/or capability. For example, the first player may be a young child and the second player may be the parent of the child. The parent would like to play a game with the child but does not wish to play an overly simplistic game. Similarly, the child wants to be able to play against the parent in the game the parent plays. However, because of the young child's age, the child is not capable of playing directly against the parent. Previously, in such a situation, the parent would have to intentionally play badly to allow the child to have a positive experience while playing and, in some cases, the child would still be unsatisfied knowing the parent lost intentionally.

In a system according to this disclosure, the parent's gameplay may be configured as unassisted gameplay while the young child's gameplay may be configured to provide a high-degree of gameplay complexity assistance. In such a case, a simulated player model may be selected based on the parent's skill level. In some examples, the simulated player model may be the simulated player model the parent normally plays against in a single player mode. However, this is not limitation and other examples may select a more or less difficult simulated player model (e.g., because the performance of the simulated player model will be influenced based on the prompted input of the child player).

The selected simulated player model may be configured to provide the appropriate or selected level of gameplay complexity assistance. As mentioned above, the young child may be provided with a highest or full level of gameplay complexity assistance (e.g., with minimal controls left to the child and/or low thresholds for success on prompted input).

For example, in a scenario in which the parent and child are playing a soccer video game, the simulated player model may fully control the child's team in the matchup (e.g., all controls normally input to the game to control the child's team are determined by the simulated player model). While controlling the child's team, the gaming system may monitor the operation of the simulated player model to determine the occurrence of a gameplay complexity interaction trigger. For example, a gameplay complexity interaction trigger may be the determination by the simulated player model to attempt the in-game action of kicking the ball into the goal. Upon determining to make the attempt to kick the ball, the gaming system may prompt the child player for a simplified input associated with the attempt to kick the ball. In a particular example, the child may be prompted for a timed input in which the child would attempt to press a button on a game controller as an animated meter filled (e.g., the child may be prompted to press the button when the animated meter is as close to full as possible). The gaming system may then introduce a deviation to the determination of controls associated with the in-game action by the simulated player model based on how close to full the animated meter was when the child pressed the button. In this way, the gameplay complexity for the child would be significantly reduced but the child would still be able to feel an accomplishment for scoring against the parent. Similarly, the parent would be able to play an appropriately challenging opponent instead of having to intentionally play poorly. In other words, both players could enjoy playing a match that is engaging on both ends, where it would otherwise be one sided.

Further, as mentioned above, the gameplay complexity assistance system disclosed herein may provide levels of assistance to players depending on preference or skill, ability or capability levels. For example, in a variation of the above scenario, the parent may wish to play a two versus two game with the child and two additional children. In this example, the two additional children may include a second child that is more capable than the above discussed young child (hereinafter first child) and a third child that wishes for a low level of gameplay complexity assistance.

In the case of the second child, the gameplay complexity assistance system may operate in the same manner as discussed above, but with more types of and more frequent interaction triggers and/or prompts and/or the “test” or “check” associated with the prompt may be more complex than that requested from the first child but less complex than otherwise unassisted gameplay.

In the case of the third child, the gameplay complexity assistance system may configure the simulated player model assisting the third child to control a subset of the available controls or in-game actions while leaving the remaining controls or in-game actions for the third child to directly control. In the soccer video game example, the gameplay complexity assistance system may configure the simulated player model to handle more complex gameplay actions (e.g., scoring attempts, passes, etc.) while leaving directional movement control to the player. As such, as the player moves their character that has possession of the soccer ball down the field, the simulated player model may determine that a scoring attempt should be made and prompt the player in a similar fashion to that discussed above for the young child. In addition or as an alternative minimal level of gameplay complexity assistance, the gameplay complexity assistance system may provide suggestions or cues (e.g., visual, auditory, tactile, etc.) to the player based on what the simulated player model would otherwise do for the controls that are being handled by the player. For example, where the player is handling the directional movement of the character, the gameplay complexity assistance system may display an indication of the directional movement that the simulated player model would perform as a suggestion to the player.

Furthermore, the gameplay complexity assistance system may also be used to coach players by incrementally introducing more complexity to them over time (e.g., by allowing player to reduce the level of gameplay complexity assistance provided by the simulated player model). For example, as a player using assistance becomes more proficient at the discrete actions they are performing, the player may request a lower level of gameplay complexity assistance to reduce the amount of automation involved. In other words, as the player becomes more proficient, the player may choose to handle more controls and the interactions for the control handled by the simulated player model may become more complex. In some examples, as the level of gameplay complexity assistance is reduced, the prompted inputs associated with gameplay complexity interaction triggers may become more similar to the inputs needed to perform the associated in-game action in unassisted gameplay.

While the above examples involved providing gameplay complexity assistance based on skill, ability, or capability, examples are not so limited. For example, gameplay complexity of the content may be provided based on a player's preference or mood. For example, a highly skilled and capable player may simply prefer to experience the story of a story based role-playing game without having to handle the complexities of the gameplay. For example, the player may prefer to make story or high level decisions but have any combat and/or exploration handled by the gameplay complexity assistance system.

Further, examples are not limited to multiplayer gameplay scenarios in which the players know each other. For example, an online game may include a matchmaking category or game mode in which players indicate they are willing to play with opponents or teammates utilizing gameplay complexity assistance. Additionally or alternatively, players may select whether or not they are willing to play with opponents or teammates utilizing gameplay complexity assistance as part of configuring their player profile. Finally, some categories, leagues, divisions, brackets, ladders or the like may be specified to allow or disallow the utilization of gameplay complexity assistance (e.g., competitive or hardcore modes in online gaming may disallow the utilization of gameplay complexity assistance).

Certain implementations and embodiments of the disclosure will now be described more fully below with reference to the accompanying figures, in which various aspects are shown. However, the various aspects may be implemented in many different forms and should not be construed as limited to the implementations set forth herein. It will be appreciated that the disclosure encompasses variations of the embodiments, as described herein. Like numbers refer to like elements throughout.

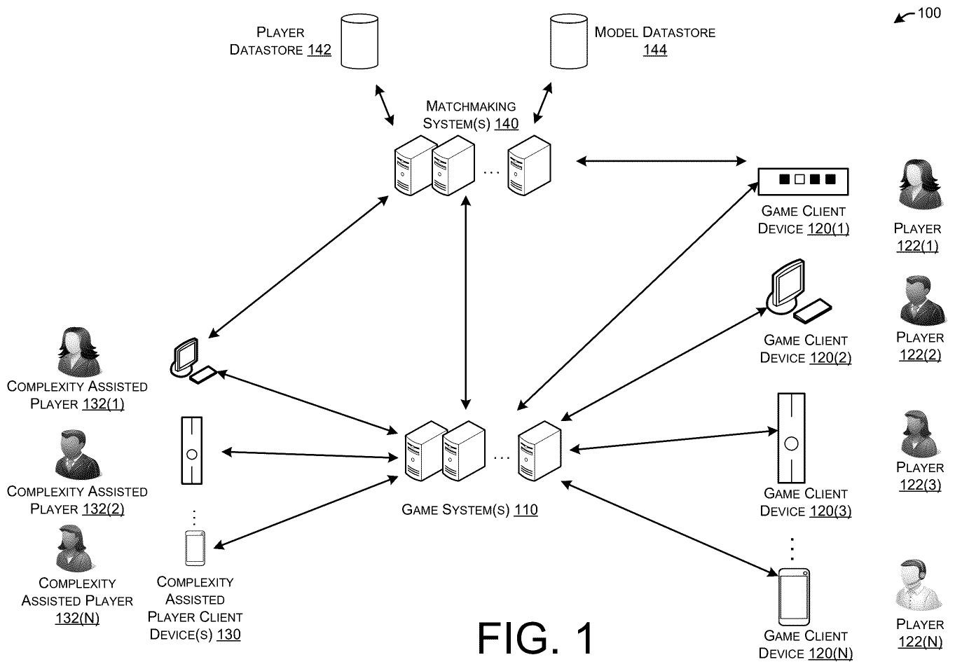

FIG. 1 illustrates a schematic diagram of an example environment 100 with game system(s) 110, game client device(s) 120 and complexity assisted player client device(s) 130 that enable online gaming, in accordance with example embodiments of the disclosure.

The example environment 100 may include one or more player(s) 122(1), 122(2), 122(3), . . . 124(N), hereinafter referred to individually or collectively as player(s) 122, who may interact with respective game client device(s) 120(1), 120(2), 120(3), . . . 120(N), hereinafter referred to individually or collectively as game client device(s) 120 via respective input device(s), without receiving gameplay complexity assistance.

The example environment 100 may further include one or more complexity assisted player(s) 132(1), 132(2), . . . 132(N), hereinafter referred to individually or collectively as complexity assisted player(s) 132, who may be provided with gameplay complexity assistance during gameplay by the complexity assisted player client device(s) 130.

The game client device(s) 120 and the complexity assisted player client device(s) 130 may receive game state information from the one or more game system(s) 110 that may host the online game played by the player(s) 122 and/or complexity assisted player(s) 132 of environment 100. The game state information may be received repeatedly and/or continuously and/or as events of the online game transpire. The game state information may be based at least in part on the interactions that each of the player(s) 122 and/or complexity assisted player(s) 132 have in response to events of the online game hosted by the game system(s) 110.

The game client devices 120 and the complexity assisted player client device(s) 130 may be configured to render content associated with the online game to respective players 122 and 132 based at least on the game state information. More particularly, the game client device(s) 120 and the complexity assisted player client device(s) 130 may use the most recent game state information to render current events of the online game as content. This content may include video, audio, haptic, combinations thereof, or the like content components. Further, the complexity assisted player client device(s) 130 may be configured to present the game state information to the simulated player model(s) that may provide the controls on behalf of the complexity assisted player(s).

As events transpire in the online game, the game system(s) 110 may update game state information and send that game state information to the game client device(s) 120 and complexity assisted player client device(s) 130. For example, if the players 122 and/or players 132 are playing an online soccer game, and the player 122 or player 132 (or corresponding simulated player model) playing one of the goalies moves in a particular direction, then that movement and/or goalie location may be represented in the game state information that may be sent to each of the game client device(s) 120 and complexity assisted player client device 130 for rendering the event of the goalie moving in the particular direction. In this way, the content of the online game is repeatedly updated throughout gameplay.

When the game client device(s) 120 receive the game state information from the game system(s) 110, a game client device 120 may render updated content associated with the online game to its respective player 122. This updated content may embody events that may have transpired since the previous state of the game (e.g., the movement of the goalie).

The game client device(s) 120 may accept input from respective players 122 via respective input device(s). The input from the players 122 may be responsive to events in the online game. For example, in an online basketball game, if a player 122 sees an event in the rendered content, such as an opposing team's guard blocking the point, the player 122 may use his/her input device to try to shoot a three-pointer. The intended action by the player 122, as captured via his/her input device, may be received by the game client device 120 and sent to the game system(s) 110.

As discussed above, the complexity assisted player client device(s) 130 may provide gameplay complexity assistance to the complexity assisted player(s) 132 using a simulated player model to generate at least some controls on behalf of the complexity assisted player(s) 132 which may be combined with additional controls from the complexity assisted player(s) to form a complete set of controls for the complexity assisted player(s). The operation of the complexity assisted player client device(s) 130 is discussed in more detail below.

When the complexity assisted player client device(s) 130 receive the game state information from the game system(s) 110, the complexity assisted player client device(s) 130 may present updated content associated with the online game to the simulated player model and render the updated content associated with the online game to its respective complexity assisted player 132. This updated content may embody events that may have transpired since the previous state of the game (e.g., the movement of the goalie).

The complexity assisted player client device(s) 130 may utilize a simulated player model to generate simulated input on behalf of the respective complexity assisted players 132. The input from the simulated player model may be responsive to events in the online game. For example, in the online basketball game discussed above, if the game state information input to the simulated player model indicates an event has occurred in the online game, such as an opposing team's guard blocking the point guard, the simulated player model may generate simulated input to try to shoot a three-pointer.

The complexity assisted player client device(s) 130 may accept input from respective players 132 via respective input device(s). For example, the operation of the complexity assisted player client device(s) 130 may include prompting the complexity assisted player(s) for interaction input that may be used to influence or adjust the controls generated by the simulated player model to perform an in-game action. For example, complexity assisted player client device(s) 130 may monitor the operation of the simulated player model to determine the occurrence of a gameplay complexity interaction trigger. In response, the complexity assisted player client device(s) 130 may present a prompt to the player in the rendered output for the interaction trigger and receive a player input in response to the prompt. The complexity assisted player client device(s) 130 may then control the simulated player model for at least one action associated with the interaction trigger based on the player input.

Further, the input from the players 132 may be responsive to events in the online game. For example, simulated player model may be configured to handle a subset of the overall player controls in the game on behalf of the player while other player controls may remain for the player to control. As such, the complexity assisted player client device(s) 130 may receive additional input from the player 132 for the other player controls that remain for the player to control.

The complexity assisted player client device(s) 130 may combine the simulated input generated by the simulated player model with any additional input from the player 132. The combined input may then be sent to the game system(s) 110.

The game client device(s) 120 and complexity assisted player client device(s) 130 may be any suitable device, including, but not limited to a Sony Playstation® line of systems, a Nintendo Switch® line of systems, a Microsoft Xbox® line of systems, any gaming device manufactured by Sony, Microsoft, Nintendo, or Sega, an Intel-Architecture (IA)® based system, an Apple Macintosh® system, a netbook computer, a notebook computer, a desktop computer system, a set-top box system, a handheld system, a smartphone, a personal digital assistant, combinations thereof, or the like. In general, the game client device(s) 120 and complexity assisted player client device(s) 130 may execute programs thereon to interact with the game system(s) 110 and render game content based at least in part on game state information received from the game system(s) 110. Additionally, the game client device(s) 120 and complexity assisted player client device(s) 130 may send indications of input to the game system(s) 110. Game state information and input information may be shared between the game client device(s) 120 and the game system(s) 110 using any suitable mechanism, such as application program interfaces (APIs).

The game system(s) 110 may receive inputs from various player(s) 122, player(s) 132 and/or simulated player models and update the state of the online game based thereon. As the state of the online game is updated, the state may be sent to the game client device(s) 120 and the complexity assisted player client device(s) 130 for rendering online game content to players 122 and 132 and for presentation to the simulated player models of the complexity assisted player client device(s) 130. In this way, the game system(s) 110 may host the online game.

The example environment 100 may further include matchmaking system(s) 140 to match players 122 and player 132 who wish to play the same game and/or game mode with each other. The matchmaking system(s) 140 may receive an indication from the game system(s) 110 of players 122 and player(s) 132 who wish to play an online game.

As discussed below, in some examples, the factors considered in matching complexity assisted players 132 to players 122 may be the same or similar to those utilized when only matching among players 122.

The matchmaking system(s) 140 may access information about the player(s) 122 and/or complexity assisted player(s) 132 who wish to play a particular online game, such as from a player datastore 142. A user account for each of the players 122 and complexity assisted players 132 may associate various information about the respective players 122 and players 132 and may be stored in the player datastore 142 and accessed by the matchmaking system(s) 140.

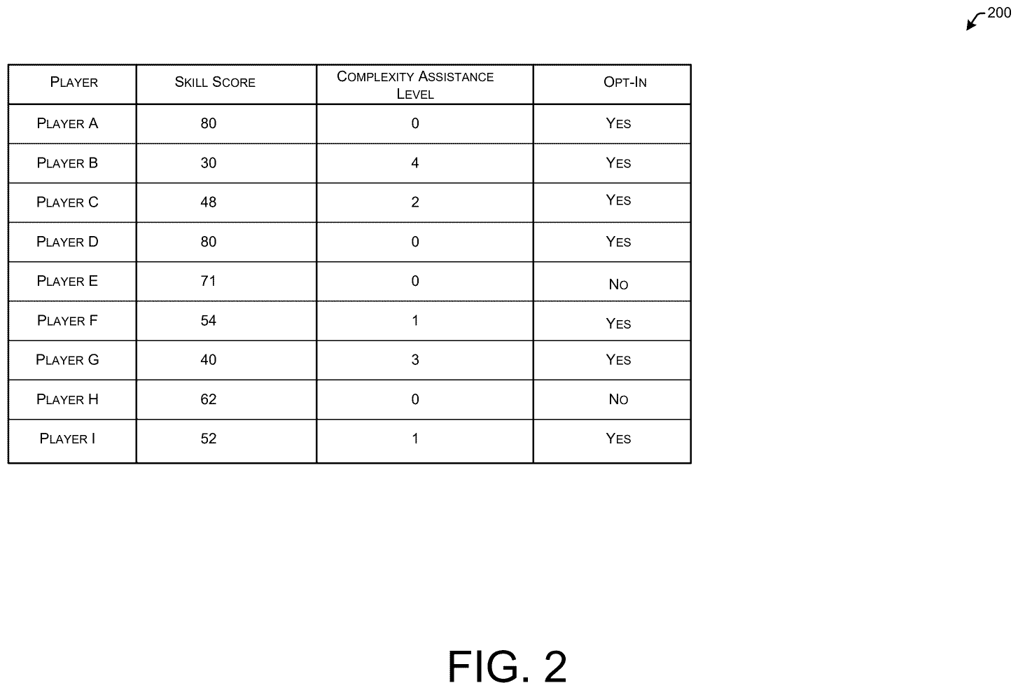

FIG. 2 illustrates a chart 200 of an example set of player matchmaking information including each player's respective skill score, level of gameplay complexity assistance and opt-in to play with other players receiving gameplay complexity assistance, in accordance with example embodiments of the disclosure. In some examples, the illustrated set of player matchmaking information including each player's respective skill score, level of gameplay complexity assistance and opt-in to play with other players receiving gameplay complexity assistance may be related to a particular game or game mode.

The chart 200 shows a number of players, such as player A through player I who have corresponding skill scores as shown. For example, player C may have a skill score of 48, while player H may have a skill score of 62. The skill scores used in this example may be on a 0-100 range, but any suitable range (e.g., 0-1, 0-50, etc.) may be used. As discussed above, the skill scores may be determined by the matchmaking system(s) 140 by accessing a player datastore 142. In some examples, the matchmaking system(s) 140, by using a player's identifier, may be able to access the player's skill score from the player datastore 142.

The chart 200 further shows whether the player has requested gameplay complexity assistance and/or what level of gameplay complexity assistance the player has requested. For example, player D's complexity assistance level of “0” may reflect that the player does not request any gameplay complexity assistance, while player B's complexity assistance level of “4” may reflect that the player has requested the highest level of gameplay complexity assistance and player F's complexity assistance level of “1” may reflect that the player has requested the lowest level of gameplay complexity assistance. In some examples, the matchmaking system(s) 140, by using a player's identifier, may determine whether a player has requested gameplay complexity assistance using the player's complexity assistance level from the player datastore 142.

The chart 200 further shows whether the player has opted-in to play with other players receiving gameplay complexity assistance. For example, player A's opt-in of “Yes” may indicate that player A is willing to match and play with other players that are receiving gameplay complexity assistance despite player A not requesting gameplay complexity assistance. On the other hand, player E's opt-in of “No” may indicate that player E is not willing to match and play with other players that are receiving gameplay complexity assistance. In the illustrated example, for case of illustration, players who have requested gameplay complexity assistance but have not opted-in to play with other players receiving gameplay complexity assistance are not shown. Depending on the implementation, the opt-in may automatically be changed to “Yes” when a player requests gameplay complexity assistance or an opt-in of “No” may be ignored for matchmaking purposes while the player's complexity assistance level is not “0”. In some examples, the matchmaking system(s) 140, by using a player's identifier, may determine whether the player has opted-in to play with other players receiving gameplay complexity assistance using the player's Opt-In value from the player datastore 142.

Returning to FIG. 1 and as discussed above, examples are not limited to gameplay scenarios in which the players know each other and may include online play. For example, the online game may include a gameplay mode in which players that have indicated they are willing to be matched and play with opponents or teammates utilizing gameplay complexity assistance. Additionally or alternatively, players may select whether or not they are willing to be matched and play with opponents or teammates utilizing gameplay complexity assistance as part of configuring their player profiles. Finally, some categories, leagues, divisions, brackets, ladders or the like in online gaming may be specified to allow or disallow the utilization of gameplay complexity assistance.

Player(s) 122 and/or complexity assisted player(s) 132 may be matched according to one or more metrics associated with the player(s) 122 and/or complexity assisted player(s) 132, such as a skill at a particular game or the availability of a simulated player model in the model datastore 144 with an appropriate skill rating for the players 122. For example, the model datastore 144 may include model datastore entries for respective simulated player models that may be utilized in providing gameplay complexity assistance and/or as computer-controlled characters during gameplay. The model datastore entries may include the same or similar information utilized in matchmaking as the user accounts stored in the player datastore 142. Of course, either the user accounts or the model datastore entries may include additional or different information in accordance with the particular implementation.

In a skill score based matchmaking example, when a plurality of players 122 wish to play an online game, the online game may be formed by matching players 122 with relatively similar skill scores. A player's skill score in a particular game may be an estimate of a player's expected performance in that game based at least in part on historic game performance data. A player who exhibits a relatively higher level of skill compared to another player may have a higher skill score than the other player. By enabling games with players of relatively similar skill scores, and therefore relatively similar skill levels, a more enjoyable game may be achieved for the players than if there is a relatively high disparity in the skill scores and/or skill levels of the players.

Once the matchmaking system(s) 140 has accessed the player skill scores, the matchmaking system(s) 140 may be configured to match player(s) 122 and/or simulated player models for the players 132 based at least in part on their respective skill scores. The players 132 requesting gameplay complexity assistance may be included into instances of the online game using various approaches. For example, players 132 may be added into instances of the online game for which an available simulated player model is within a threshold value of the skill score of the players 122.

In addition to or alternatively to skill scores, players 122 and players 132 may be matched on a variety of other factors.

Some example matchmaking factors may be related to behavior in addition to skill and may include a player's playstyle. For example, when matching player(s) 122 and/or simulated player model(s) for players 132 as a team for a team deathmatch, the matchmaking system(s) 140 may favor matching player(s) 122 and/or simulated player models that exhibit similar levels of aggression or a mix of levels of aggression. This may alleviate the frustration experienced by players when deathmatch teams split up due to different players utilizing different tactics. Splitting a deathmatch team into different groups using different tactics can often result in a loss to an opposing team operating as a single unit with a shared tactical approach. In another example, when matching player(s) 122 and/or player(s) 132 as a team for a team-based sports game (e.g., an online team based American football game), the matchmaking system(s) 140 may favor matching player(s) 122 and/or simulated player models for player(s) 132 based on whether the players or models employ strategies consistent with real-life football games (e.g., kicking extra points or attempting a two point conversion according to the situation) in the online game or employ overly aggressive, fanciful, or unrealistic strategies inconsistent with real-life football games (e.g., always attempting the two point conversion or attempting to convert every fourth down). Many other aspects of playstyles may be utilized in matchmaking. The aspects of playstyles utilized for different genres or different individual games may vary from example to example.

Some additional example matchmaking factors may be character or setup related such as character class, team choice, position or role preference, and so on. Other matchmaking factors may be related to teammates or teams of the players 122 or the players 132.

Having matched the player(s) 122 and/or simulated player model(s) for the complexity assisted player(s) 132, the selected simulated player model(s) may be configured to provide the appropriate or selected level(s) of gameplay complexity assistance for the player(s) 132. As discussed above, a simulated player model may assist a player 132 through automating or adjusting gameplay actions normally controlled by the player 132 of the video game. For example, the simulated player model may assist a player 132 by determining and providing at least a portion of the video game control inputs for at least some in-game actions on behalf or in place of the player. The level of gameplay complexity assistance provided to the complexity assisted player(s) 132 may vary from a highest level of gameplay complexity assistance (e.g., with minimal controls and/or precision thresholds on control input by the player (e.g., in the case of a young child)) to a lower level of gameplay complexity assistance which may include the simulated player model handling minimal controls and/or suggesting controls based on what the simulated player model would control the player character to do.

In some examples, the complexity assisted player client device 130 may cause a prompt to be presented to the player for inputs that may be used to influence or to determine the video game control inputs generated by the simulated player model. In some examples, the inputs prompted from the player may be different and/or simplified in comparison to the video game control inputs determined by the simulated player model on behalf of the player. For example, a simulated player model may be instantiated in a cooperative sports game to control the player character avatar of a player who has requested gameplay complexity assistance. In an example in which the player requesting assistance has a low skill level, ability or capability, the simulated player model may act as a computer-controlled player character (e.g., a bot) while the gameplay complexity assistance system may prompt inputs from the player that may influence the actions of the computer-controlled player character that are generated by the simulated player model (e.g., influencing an accuracy or success chance of an in-game action of the simulated player model to kick or throw a ball, hit a target, choose a correct path in a maze, choose a strategy and so on).

In an example in which the player requesting assistance has an intermediate level of skill, ability or capability, the simulated player model may act in the same way as for players with low skill level, ability or capability for some controls or aspects of controlling the player character while leaving other controls or aspects of controlling the player character to the player. Another potential intermediate level of gameplay complexity assistance may include the simulated player model handling minimal controls or suggesting controls based on what the simulated player model would control the player character to do. For example, the complexity assisted player client device 130 may provide suggestions or cues (e.g., visual, auditory, tactile, etc.) to the player based on what the simulated player model would otherwise do for the controls that are being handled by the player. For example, where the player is handling the directional movement of the character, the complexity assisted player client device 130 may display an indication of the directional movement that the simulated player model would perform as a suggestion to the player.

In an example, the gaming system may begin an instance of the game for the one or more players including having the complexity assisted player client device(s) 130 instantiate the configured simulated player models for the players requesting gameplay complexity assistance. The gaming system may then begin gameplay which may include the complexity assisted player client device(s) 130 operating the simulated player models to perform game controls in place of the corresponding players for at least some controls of the players' character. The complexity assisted player client device(s) 130 may monitor the operation of the simulated player models to determine the occurrence of a gameplay complexity interaction trigger. A gameplay complexity interaction trigger may be an event or point in gameplay at which the simulated player model is configured to perform an in-game action based on a prompted input from the player (e.g., a reduced complexity input). In response, the gaming system may present a prompt to the player for the interaction trigger and receive a player input in response to the prompt. The prompt may include a check or test for success for the prompted input (e.g., whether correct buttons are pressed, a timing, or so on). The complexity assisted player client device 130 may then control the simulated player model for at least one action associated with the interaction trigger based on the player input. In some examples, the degree of success the player had in inputting the prompted input may be used to determine how well the simulated player model performs the in-game action.

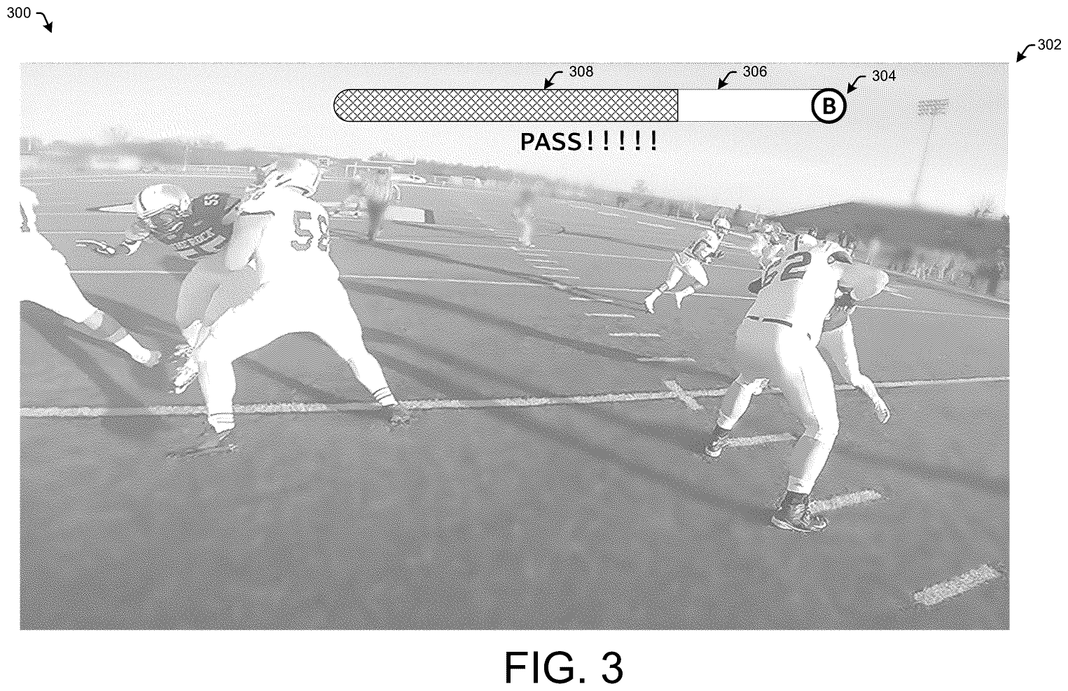

FIG. 3 illustrates an example view 300 of an example virtual environment of a video game in which gameplay complexity assistance may be provided during gameplay, in accordance with some examples herein. More particularly, in the illustrated example, a player may be provided with gameplay complexity assistance in an American football game.

As illustrated, in the output 302 displayed to the player, a simulated player model has controlled a quarterback to move into the displayed viewing position while a receiver has become “open” to receive the football. The simulated player model may determine that it will attempt the in-game action to pass the ball to the receiver. The complexity assisted player client device(s) 130 may detect the determination to pass the football as an interaction trigger. In response, the complexity assisted player client device(s) 130 may cause a prompt to be displayed for the interaction trigger. In the illustrated example, the complexity assisted player client device(s) 130 may output the prompt as an animated meter including the button 304 to be pressed and a meter body 306 that is being filled by the animation 308. As discussed above, the player 132 may attempt to press the button 304 indicated when the animated meter 306 is as close to full as possible. The complexity assisted player client device(s) 130 may then introduce a deviation to the pass attempt by the simulated player model based on how close to full the animated meter 306 was when the player 132 pressed the button.

Although the examples illustrated herein are shown as including animated meters as a prompt for user input, examples are not so limited and one of ordinary skill in the art would understand how to implement a variety prompts for such inputs. For example, as the level of gameplay complexity assistance is reduced more types of and/or more frequent interaction triggers may be generated. Further, the “tests” or “checks” associated with the prompt may become more complex as the level of gameplay complexity assistance is reduced. For example, the prompted input may include a series of inputs from by the player to an input device. In some examples, as the level of gameplay complexity assistance is reduced, the prompted inputs associated with gameplay complexity interaction triggers may become more similar to the inputs needed to perform the associated in-game action in unassisted gameplay.

Returning to FIG. 1, the matchmaking system(s) 140 may trigger and instruct generation of instance(s) of the online game(s) for the match(es). More particularly, the matchmaking system(s) 140 may send the configured simulated player model(s) of any complexity assisted player(s) 132 to be included in an instance of the online game to the complexity assisted player client device(s) 130 with instructions for the complexity assisted player client device(s) 130 to instantiate the simulated player model for the complexity assisted player 132. The matchmaking system(s) 140 may then request the game system(s) 110 instantiate an online game between the matched players 122 and complexity assisted players 132. For example, the matchmaking system(s) 140 may provide connection information for the game client device(s) 120 and complexity assisted player client device(s) 130 to the game system(s) 110 for instantiation of an instance of the online game between the matched players 122 and complexity assisted players 132.

In some examples, the simulated player models may be machine learned models that are trained based on the behavior of human players. For example, a simulated player models for a human player may be trained based on inputs of the respective human player in various situations. As a result of the training, simulated player models may behave in a similar manner to the human player when presented with similar situations. In other examples, the simulated player models may be generic simulations of players of a given skill level. Such generic simulations may be trained based on aggregated behavior data from human players of the generic skill level. Though embodiments are not limited any particular system or method of generating the underlying instructions or logic that may operate simulated player models (e.g., whether using machine learned models, other machine learning or explicit programming), an example for generating and operating simulated players is given in U.S. patent application Ser. No. 15/985,347, which is incorporated by reference herein in its entirety. Additionally or alternatively, the simulated player models may be any other type of model that may output controls for a player character or player interface in a game.

Though example implementation details are discussed above, variations are possible. For example, while the examples discussed above relate to an online gaming system, other examples may relate to a player device executing the video game locally. Such an example may include a single player mode or a local multiplayer mode (e.g., local co-op or competitive modes). Further, while illustrated separately, the game client device(s) 120 may become complexity assisted player client device(s) 130 if the player thereof requests gameplay complexity assistance and complexity assisted player client device(s) 130 may become game client device(s) 120 should the player(s) thereof request the gameplay complexity assistance be disabled. Further, while the examples discussed herein relate to the player(s) selecting a level of gameplay complexity assistance, other examples may include the player requesting gameplay complexity assistance and the gaming system, matchmaking system or other device determining a level of gameplay complexity assistance based on the player's skill score. In such an example, the level of gameplay complexity assistance may be reduced by the system over time as the player becomes more proficient.

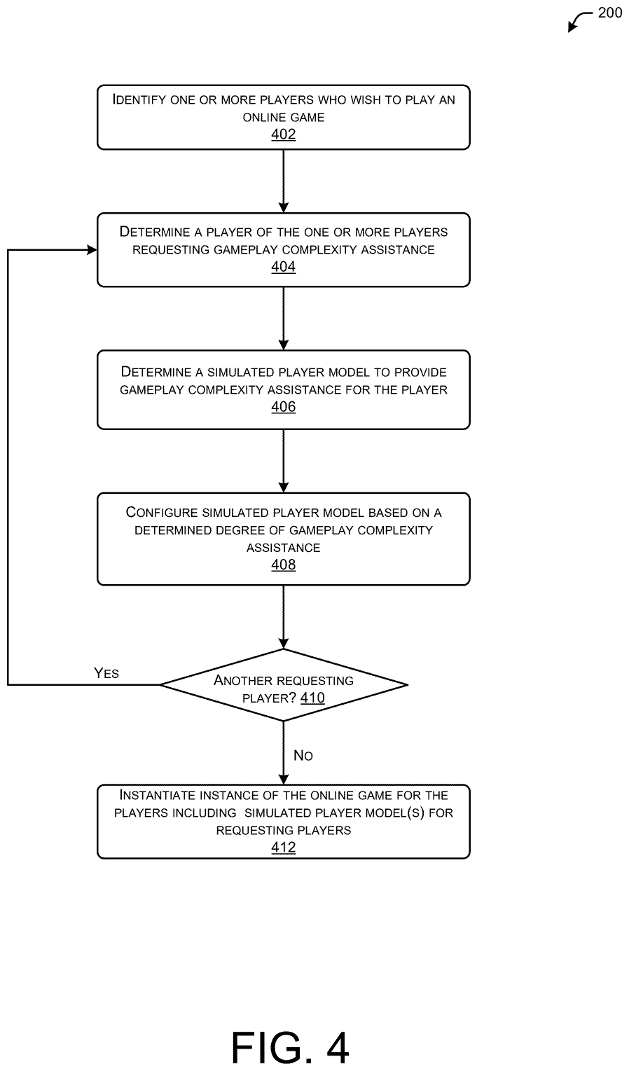

FIG. 4 illustrates a flow diagram of an example method 400 to match players to form one or more online games including players receiving gameplay complexity assistance, in accordance with example embodiments of the disclosure. The method 400 may be performed by the matchmaking system(s) 140, individually or in cooperation with one or more other elements of the environment 100.

At block 402, one or more player(s) who wish to play an online game may be identified. For example, the one or more player(s) may be identified by the matchmaking system(s) 140 based at least in part on a message and/or an indication from the game system(s) 110 and/or game client device(s) 120 or complexity assisted player client device(s) 130 that the one or more player(s) 122 or 132 wish to play the online game.

At block 404, the matchmaking system(s) 140 may determine a player 132 among the identified players that is requesting gameplay complexity assistance. As discussed above, player(s) 132 may request gameplay complexity assistance while configuring or reconfiguring the player(s)' profile(s). In such an example, the matchmaking system(s) 140 may determine the player has requests gameplay complexity assistance based on the player's profile.

Then, at block 406, the matchmaking system(s) 140 may determine a simulated player model to provide gameplay complexity assistance for the player. As discussed above, the matchmaking system(s) 140 may determine the simulated player model based on similar factors normally used in matchmaking for players. More particularly, the matchmaking system(s) 140 may determine a simulated player model appropriate to play with or against the other players 122 wishing to play the online game. However, examples are not so limited and other factors may be used in determining a simulated player model or, in some examples, a particular simulated player model may be utilized for all player's requesting gameplay complexity assistance.

At block 408, the matchmaking system(s) 140 may configure the simulated player model to provide a determined degree of gameplay complexity assistance to the player. As discussed above, player(s) 132 may request the degree of gameplay complexity assistance while configuring or reconfiguring the player(s)' profile(s) and the player's profile information may be utilized in configuring the simulated player model. However, examples are not so limited to those providing multiple degrees of gameplay complexity assistance and example may provide the same degree of gameplay complexity assistance to each requesting player.

At block 410, the matchmaking system(s) 140 may determine whether another player is requesting gameplay complexity assistance. If so, the process may return to block 404 to handle the next player's request for gameplay complexity assistance. If not, the process may continue to block 412.

At block 412, the matchmaking system(s) 140 may instantiate an instance of the online game for the players. The instance of the online game may be instantiated to include the configured simulated player model(s) for the players 132 requesting gameplay complexity assistance.

It should be noted that some of the operations of method 400 may be performed out of the order presented, with additional elements, and/or without some elements. Some of the operations of method 400 may further take place substantially concurrently and, therefore, may conclude in an order different from the order of operations shown above. Further, implementations are not limited to the details of the above examples and variations are possible.

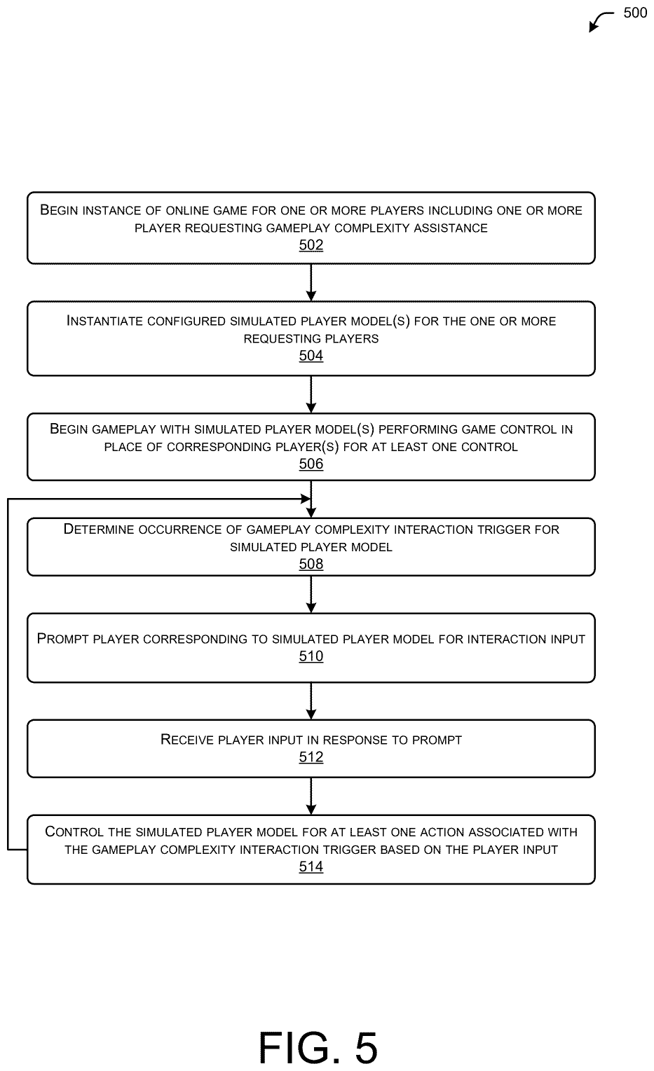

FIG. 5 illustrates a flow diagram of an example method 500 to provide gameplay complexity assistance to one or more players during gameplay of an instance of an online game, in accordance with example embodiments of the disclosure. In some examples, the method 500 follows method 400. However, examples are not so limited and methods 400 and 500 may both be performed separately or in conjunction. The method 500 may be performed by the gaming system(s) 110 and the complexity assisted player client device(s) 130, individually or in cooperation with one or more other elements of the environment 100.

At block 502, the gaming system(s) 110 may begin an instance of the online game for one or more players including one or more player requesting gameplay complexity assistance. In some examples, the instance of the online game may be instantiated by the matchmaking system(s) 140 as discussed above. In some examples, one or more of the gaming system(s) 110 or the matchmaking system(s) 140 may provide configuration and communication information to the game client device(s) 120 and complexity assisted player client device(s) 130 of the one or more players including providing configuration information of any simulated player models to provide gameplay complexity assistance.

At block 504, the complexity assisted player client device(s) 130 may instantiate the configured simulated player model(s) for the one or more requesting players. Then, at block 506, the gaming system(s) 110 and client devices 120 and 130 may begin gameplay of the instance of the online game with simulated player model(s) performing at least a portion of the game controls for the online game in place of corresponding player(s) 132.

Blocks 508-514 may be performed by the complexity assisted player client device(s) 130 during gameplay to handle interaction triggers for which the player may provide reduced complexity input.

At block 508, the complexity assisted player client device(s) 130 may determine that a gameplay complexity interaction trigger has occurred for a simulated player model. As discussed above, a gameplay complexity interaction trigger may be an event or point in gameplay which the simulated player model is configured to utilize a reduced complexity input to perform an in-game action. At block 510, the complexity assisted player client device(s) 130 may prompt the player corresponding to the simulated player model for an interaction input. At block 512, the complexity assisted player client device(s) 130 may receive a player input in response to the prompt. Then, at block 514, the complexity assisted player client device(s) 130 may control the simulated player model for at least one action associated with the gameplay complexity interaction trigger based on the player's interaction input.

Blocks 508-514 may be repeated by the complexity assisted player client device(s) 130 during gameplay for each gameplay complexity interaction trigger that occurs. Additional details relating to the performance of gameplay and/or handling gameplay complexity interaction triggers are discussed above.

It should be noted that some of the operations of method 500 may be performed out of the order presented, with additional elements, and/or without some elements. Some of the operations of method 500 may further take place substantially concurrently and, therefore, may conclude in an order different from the order of operations shown above.

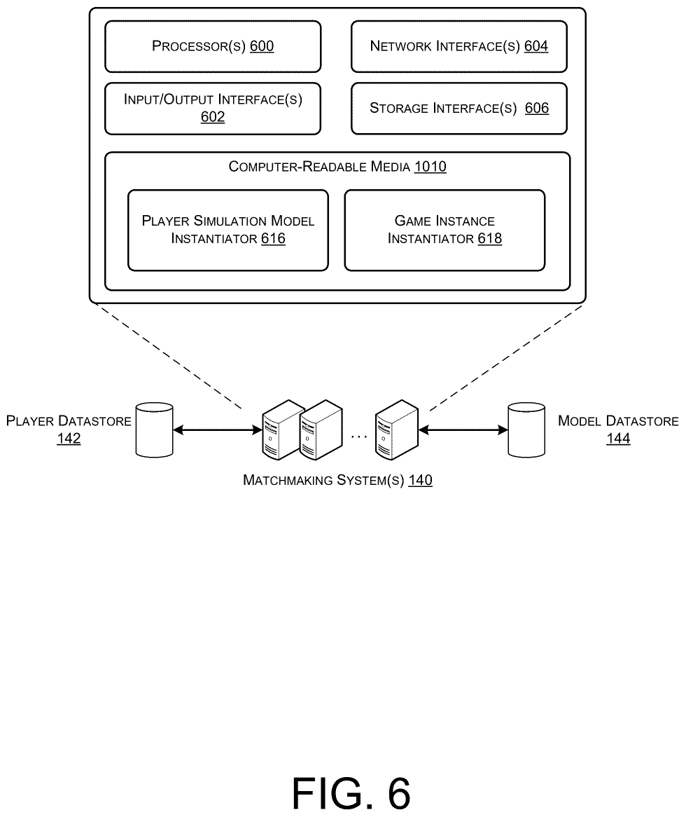

FIG. 6 illustrates a block diagram of example matchmaking system(s) 140 that may provide for gameplay complexity assistance in online gaming, in accordance with example embodiments of the disclosure. The matchmaking system(s) 140 may include one or more processor(s) 600, one or more input/output (I/O) interface(s) 602, one or more network interface(s) 604, one or more storage interface(s) 606, and computer-readable media 610.

In some implementations, the processors(s) 600 may include a central processing unit (CPU), a graphics processing unit (GPU), both CPU and GPU, a microprocessor, a digital signal processor or other processing units or components known in the art. Alternatively, or in addition, the functionally described herein can be performed, at least in part, by one or more hardware logic components. For example, and without limitation, illustrative types of hardware logic components that may be used include field-programmable gate arrays (FPGAs), application-specific integrated circuits (ASICs), application-specific standard products (ASSPs), system-on-a-chip system(s) (SOCs), complex programmable logic devices (CPLDs), etc. Additionally, each of the processor(s) 600 may possess its own local memory, which also may store program modules, program data, and/or one or more operating system(s). The one or more processor(s) 600 may include one or more cores.

The one or more input/output (I/O) interface(s) 602 may enable the matchmaking system(s) 140 to detect interaction with a user and/or other system(s), such as one or more game system(s) 110. The I/O interface(s) 602 may include a combination of hardware, software, and/or firmware and may include software drivers for enabling the operation of any variety of I/O device(s) integrated on the matchmaking system(s) 140 or with which the matchmaking system(s) 140 interacts, such as displays, microphones, speakers, cameras, switches, and any other variety of sensors, or the like.

The network interface(s) 604 may enable the matchmaking system(s) 140 to communicate via the one or more network(s). The network interface(s) 604 may include a combination of hardware, software, and/or firmware and may include software drivers for enabling any variety of protocol-based communications, and any variety of wireline and/or wireless ports/antennas. For example, the network interface(s) 604 may comprise one or more of a cellular radio, a wireless (e.g., IEEE 802.1x-based) interface, a Bluetooth® interface, and the like. In some embodiments, the network interface(s) 604 may include radio frequency (RF) circuitry that allows the matchmaking system(s) 140 to transition between various standards. The network interface(s) 604 may further enable the matchmaking system(s) 140 to communicate over circuit-switch domains and/or packet-switch domains.

The storage interface(s) 606 may enable the processor(s) 600 to interface and exchange data with the computer-readable medium 610, as well as any storage device(s) external to the matchmaking system(s) 140, such as the player datastore 142 and the model datastore 144.

The computer-readable media 610 may include volatile and/or nonvolatile memory, removable and non-removable media implemented in any method or technology for storage of information, such as computer-readable instructions, data structures, program modules, or other data. Such memory includes, but is not limited to, random access memory (RAM), read-only memory (ROM), electrically erasable programmable read-only memory (EEPROM), flash memory or other memory technology, CD-ROM, digital versatile discs (DVD) or other optical storage, magnetic cassettes, magnetic tape, magnetic disk storage or other magnetic storage devices, RAID storage system(s), or any other medium which can be used to store the desired information and which can be accessed by a computing device. The computer-readable media 610 may be implemented as computer-readable storage media (CRSM), which may be any available physical media accessible by the processor(s) 600 to execute instructions stored on the computer readable media 610. In one basic implementation, CRSM may include RAM and Flash memory. In other implementations, CRSM may include, but is not limited to, ROM, EEPROM, or any other tangible medium which can be used to store the desired information and which can be accessed by the processor(s) 600. The computer-readable media 610 may have an operating system (OS) and/or a variety of suitable applications stored thereon. The OS, when executed by the processor(s) 600 may enable management of hardware and/or software resources of the matchmaking system(s) 140.

Several functional blocks having instruction, data stores, and so forth may be stored within the computer-readable media 610 and configured to execute on the processor(s) 600. The computer readable media 610 may have stored thereon a player simulation model instantiator block 612 and a game instance instantiator block 614. It will be appreciated that each of the functional blocks 612 and 614 may have instructions stored thereon that when executed by the processor(s) 600 may enable various functions pertaining to the operations of the matchmaking system(s) 140 discussed above. Of course, other functional blocks for performing other functions of the matchmaking system(s) 140 may be included or stored within the computer-readable media 610.

The instructions stored in the player simulation model instantiator block 612, when executed by the processor(s) 600, may configure the matchmaking system(s) 140 to instantiate and/or configure simulated player model(s) to provide a requested level of gameplay complexity assistance as discussed above.

The instructions stored in the game instance instantiator block 614, when executed by the processor(s) 600, may configure the matchmaking system(s) 140 to instantiate an instance of an online game between one or more players 122 and/or players 132 including causing the complexity assisted player client device(s) 130 to provide gameplay complexity assistance using the simulated player models selected and configured by the matchmaking system(s) 140.

It should be understood that the original applicant herein determines which technologies to use and/or productize based on their usefulness and relevance in a constantly evolving field, and what is best for it and its players and users. Accordingly, it may be the case that the systems and methods described herein have not yet been and/or will not later be used and/or productized by the original applicant. It should also be understood that implementation and use, if any, by the original applicant, of the systems and methods described herein are performed in accordance with its privacy policies. These policies are intended to respect and prioritize player privacy, and to meet or exceed government and legal requirements of respective jurisdictions. To the extent that such an implementation or use of these systems and methods enables or requires processing of user personal information, such processing is performed (i) as outlined in the privacy policies; (ii) pursuant to a valid legal mechanism, including but not limited to providing adequate notice or where required, obtaining the consent of the respective user; and (iii) in accordance with the player or user's privacy settings or preferences. It should also be understood that the original applicant intends that the systems and methods described herein, if implemented or used by other entities, be in compliance with privacy policies and practices that are consistent with its objective to respect players and user privacy.

The illustrated aspects of the claimed subject matter may also be practiced in distributed computing environments where certain tasks are performed by remote processing devices that are linked through a communications network. In a distributed computing environment, program modules can be located in both local and remote memory storage devices.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

The disclosure is described above with reference to block and flow diagrams of system(s), methods, apparatuses, and/or computer program products according to example embodiments of the disclosure. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the disclosure.

Computer-executable program instructions may be loaded onto a general purpose computer, a special-purpose computer, a processor, or other programmable data processing apparatus to produce a particular machine, such that the instructions that execute on the computer, processor, or other programmable data processing apparatus for implementing one or more functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction that implement one or more functions specified in the flow diagram block or blocks. As an example, embodiments of the disclosure may provide for a computer program product, comprising a computer usable medium having a computer readable program code or program instructions embodied therein, said computer readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

It will be appreciated that each of the memories and data storage devices described herein can store data and information for subsequent retrieval. The memories and databases can be in communication with each other and/or other databases, such as a centralized database, or other types of data storage devices. When needed, data or information stored in a memory or database may be transmitted to a centralized database capable of receiving data, information, or data records from more than one database or other data storage devices. In other embodiments, the databases shown can be integrated or distributed into any number of databases or other data storage devices.

Many modifications and other embodiments of the disclosure set forth herein will be apparent having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system, comprising:
one or more processors; and
one or more computer-readable media storing computer-executable instructions that, when executed by the one or more processors, cause the one or more processors to:
operate, during gameplay of a game including a set of controls for a player of the game, a simulated player model to provide gameplay complexity assistance for the player including:
inputting a game state of the game to the simulated player model to cause the simulated player model to generate at least one simulated control corresponding to at least one control of the set of controls for the player; and
receiving the at least one simulated control input from the simulated player model; and
utilize, in the gameplay of the game, the at least one simulated control input from the simulated player model as a player input of the corresponding one of the set of controls of the player.

2. The system of claim 1, wherein the computer-executable instructions further cause the one or more processors to:
determine an occurrence of an interaction trigger in the gameplay of the game;
output, in response to the occurrence of the interaction trigger, a prompt for the player to input an interaction input, wherein the interaction input is different from the at least one simulated control input;
receive, subsequent to the outputting of the prompt, a prompted input from the player; and
control the generation of the at least one simulated control input by the simulated player model based at least in part on the prompted input.

3. The system of claim 2, wherein:
the interaction trigger is a determination of the simulated player model to perform an in-game action;
the simulated player model generates a first number of control inputs of the set of controls for a player of the game to perform the in-game action; and
the interaction input includes a second number of control inputs of the set of controls for a player of the game that is smaller than the first number of control inputs.

4. The system of claim 2, wherein the computer-executable instructions further cause the one or more processors to:
determine a metric associated with the interaction input and the prompted input;
wherein the controlling the generation of the at least one simulated control input by the simulated player model based at least in part on the prompted input is based at least in part on the metric.

5. The system of claim 4, wherein:
the prompt includes a timing for the interaction input; and
the metric is based at least in part on a similarity of a timing of the prompted input to the timing for the interaction input.

6. The system of claim 2, wherein:
the interaction trigger is associated with an in-game action of a first set of in-game actions the simulated player model is configured to perform in place of the player;
the first set of in-game actions is associated with a first level of gameplay complexity assistance of a plurality of levels of gameplay complexity assistance; and
a second set of in-game actions associated with a second level of gameplay complexity assistance of the plurality of levels of gameplay complexity assistance includes more in-game actions than the first set of in-game actions.

7. The system of claim 1, wherein the computer-executable instructions further cause the one or more processors to:
receive one or more additional control inputs from the player; and
combine the one or more additional control inputs with the at least one simulated control input as a combined input; and
wherein the utilizing, in the gameplay of the game, the at least one simulated control input from the simulated player model as the player input utilizes the combined input as the player input.

8. A computer-implemented method comprising:
operating, during gameplay of a game including a set of controls for a player of the game, a simulated player model to provide gameplay complexity assistance for the player including:
inputting a game state of the game to the simulated player model to cause the simulated player model to generate at least one simulated control corresponding to at least one control of the set of controls for the player; and
receiving the at least one simulated control input from the simulated player model; and
utilizing, in the gameplay of the game, the at least one simulated control input from the simulated player model as a player input of the corresponding one of the set of controls of the player.

9. The computer-implemented method of claim 8, further comprising:
determining an occurrence of an interaction trigger in the gameplay of the game;
outputting, in response to the occurrence of the interaction trigger, a prompt for the player to input an interaction input, wherein the interaction input is different from the at least one simulated control input;
receiving, subsequent to the outputting of the prompt, a prompted input from the player; and
controlling the generation of the at least one simulated control input by the simulated player model based at least in part on the prompted input.

10. The computer-implemented method of claim 9, wherein:
the interaction trigger is a determination of the simulated player model to perform an in-game action;
the simulated player model generates a first number of control inputs of the set of controls for a player of the game to perform the in-game action; and
the interaction input includes a second number of control inputs of the set of controls for a player of the game that is smaller than the first number of control inputs.

11. The computer-implemented method of claim 9, the method further comprising:
determining a metric associated with the interaction input and the prompted input;
wherein the controlling the generation of the at least one simulated control input by the simulated player model based at least in part on the prompted input is based at least in part on the metric.

12. The computer-implemented method of claim 11, wherein:
the prompt includes a timing for the interaction input; and
the metric is based at least in part on a similarity of a timing of the prompted input to the timing for the interaction input.

13. The computer-implemented method of claim 9, wherein:
the interaction trigger is associated with an in-game action of a first set of in-game actions the simulated player model is configured to perform in place of the player;
the first set of in-game actions is associated with a first level of gameplay complexity assistance of a plurality of levels of gameplay complexity assistance; and
a second set of in-game actions associated with a second level of gameplay complexity assistance of the plurality of levels of gameplay complexity assistance includes more in-game actions than the first set of in-game actions.

14. The computer-implemented method of claim 8, further comprising:
receiving one or more additional control inputs from the player; and
combining the one or more additional control inputs with the at least one simulated control input as a combined input; and
wherein the utilizing, in the gameplay of the game, the at least one simulated control input from the simulated player model as the player input utilizes the combined input as the player input.

15. One or more non-transitory computer-readable media storing computer-executable instructions that, when executed by one or more processors, cause the one or more processors to perform operations comprising:
operate, during gameplay of a game including a set of controls for a player of the game, a simulated player model to provide gameplay complexity assistance for the player including:
inputting a game state of the game to the simulated player model to cause the simulated player model to generate at least one simulated control corresponding to at least one control of the set of controls for the player; and
receiving the at least one simulated control input from the simulated player model; and
utilize, in the gameplay of the game, the at least one simulated control input from the simulated player model as a player input of the corresponding one of the set of controls of the player.

16. The one or more non-transitory computer-readable media of claim 15, wherein the computer-executable instructions further cause the one or more processors to:
determine an occurrence of an interaction trigger in the gameplay of the game;
output, in response to the occurrence of the interaction trigger, a prompt for the player to input an interaction input, wherein the interaction input is different from the at least one simulated control input;
receive, subsequent to the outputting of the prompt, a prompted input from the player; and
control the generation of the at least one simulated control input by the simulated player model based at least in part on the prompted input.

17. The one or more non-transitory computer-readable media of claim 16, wherein:
the interaction trigger is a determination of the simulated player model to perform an in-game action;
the simulated player model generates a first number of control inputs of the set of controls for a player of the game to perform the in-game action; and
the interaction input includes a second number of control inputs of the set of controls for a player of the game that is smaller than the first number of control inputs.

18. The one or more non-transitory computer-readable media of claim 16, wherein the computer-executable instructions further cause the one or more processors to:
determine a metric associated with the interaction input and the prompted input;
wherein the controlling the generation of the at least one simulated control input by the simulated player model based at least in part on the prompted input is based at least in part on the metric.

19. The one or more non-transitory computer-readable media of claim 18, wherein:
the prompt includes a timing for the interaction input; and
the metric is based at least in part on a similarity of a timing of the prompted input to the timing for the interaction input.

20. The one or more non-transitory computer-readable media of claim 16, wherein:
the interaction trigger is associated with an in-game action of a first set of in-game actions the simulated player model is configured to perform in place of the player;
the first set of in-game actions is associated with a first level of gameplay complexity assistance of a plurality of levels of gameplay complexity assistance; and
a second set of in-game actions associated with a second level of gameplay complexity assistance of the plurality of levels of gameplay complexity assistance includes more in-game actions than the first set of in-game actions.
